(19) United States
(12) Patent Application Publication
(10) Pub. No.: US 2025/0110289 A1
(43) Pub. Date: Apr. 3, 2025

(54) OPTICAL CONNECTOR FERRULE

(71) Applicant: Intel Corporation, Santa Clara, CA (US)

(72) Inventors: Benjamin T. Duong, Phoenix, AZ (US); Gang Duan, Chandler, AZ (US); Sandeep Gaan, Chandler, AZ (US); Donald Hammon, Fox Island, WA (US); Wesley B. Morgan, Lake Oswego, OR (US)

(73) Assignee: Intel Corporation, Santa Clara, CA (US)

(21) Appl. No.: 18/479,004

(22) Filed: Sep. 30, 2023

(51) Int. Cl. G02B 6/38

(52) U.S. Cl. CPC G02B 6/3881

(57) ABSTRACT

A ferrule of an optical connector device is to accept one or more optical fibers in one or more fiber holes of the ferrule, the ferrule is formed from a dielectric material. The ferrule includes a face to interface with an optical socket of another device, where ends of the one or more optical fibers are exposed at the face to communicate photon signals with another device. The ferrule further includes alignment features formed in the dielectric layer to align the ends of the one or more optical fibers with one or more waveguides of the other device.

### FIELD

The present disclosure relates in general to the field of photonics, and more specifically, optical connector ferrules.

### BACKGROUND

In electronics manufacturing, integrated circuit (IC) packaging is a stage of manufacture where an IC that has been fabricated on a die or chip comprising a semiconducting material is coupled to a supporting case or “package” that can protect the IC from physical damage and support electrical interconnection of ICs, dies, or other electronic components on the package. In some cases, a package may be implemented as a printed circuit board (PCB). In the IC industry, the process of fabricating a package is often referred to as packaging, or assembly.

A photonic integrated circuit (PIC) includes integrated photonic devices or elements. PICs are preferred to optical systems built with discrete optical components and/or optical fiber because of the more compact size, lower cost, heightened functionality, and performance of PICs. Silicon PICs or silicon photonics (SiPh) have one or more planar silicon photonic waveguides having diameters less than 1 μm, which convey light within the PIC. These planar silicon waveguides terminate at an optical output coupler (OC) suitable for coupling to an optical fiber array (FA) comprising fibers having diameters on the order of a hundred microns. PICs can be used for several applications, such as communications. Efficiently and cheaply aligning optics to couple light into and out of PICs can be a challenge. Approaches such as attachment of optical fiber arrays to PICS may be slow, incompatible with conventional semiconductor packaging processes, and can result in substantial yield and throughput issues.

### BRIEF DESCRIPTION OF THE DRAWINGS

FIG. 1 is a simplified drawing of one embodiment of a system with an optical socket on an integrated circuit package.

FIG. 2 is a simplified drawing of one embodiment of a connectorized optical cable with an optical plug that can mate with the optical socket of FIG. 1.

FIG. 3 is a simplified drawing of one embodiment of the connectorized optical cable of FIG. 2 that has been disassembled.

FIG. 4 is a simplified drawing of the integrated circuit package of FIG. 1 with a lid and an optical plug.

FIG. 5 is a diagram of a simplified ferrule device.

FIGS. 6A-6B are diagrams showing views of an example ferrule device formed from a build-up dielectric material.

FIG. 7 is a diagram showing top and cross-sectional views of an example ferrule device.

FIGS. 8A-8E are diagrams illustrating a process for manufacturing an example ferrule device.

FIG. 9 is an image showing high precision definition of features formed through etching in an example build-up dielectric layer.

FIG. 10 is a simplified flow diagram of at least one embodiment of a method for manufacturing an example ferrule element for inclusion in an optical connector element.

FIG. 11 is a top view of a wafer and dies that may be included in a microelectronic assembly, in accordance with any of the embodiments disclosed herein.

FIG. 12 is a cross-sectional side view of an integrated circuit device that may be included in a microelectronic assembly, in accordance with any of the embodiments disclosed herein.

FIGS. 13A-13D are perspective views of example planar, gate-all-around, and stacked gate-all-around transistors.

FIG. 14 is a cross-sectional side view of an integrated circuit device assembly that may include a microelectronic assembly, in accordance with any of the embodiments disclosed herein.

FIG. 15 is a block diagram of an example electrical device that may include a microelectronic assembly, in accordance with any of the embodiments disclosed herein.

### DETAILED DESCRIPTION

In various embodiments disclosed herein, a connectorized optical cable with an optical plug can plug into an optical socket of an integrated circuit package. The optical plug includes a ferrule with alignment features that allow it to be precisely aligned with fibers or waveguides in an optical socket (e.g., with sub-micron precision). In order for the plug to be coarsely aligned with an optical socket, in the illustrative embodiment, a substrate of the optical socket has a cavity cut out from it, with the sidewalls of the cavity defining a coarse lateral positioning for the optical plug. An optical interposer that mates with the optical plug may be positioned on a recessed shelf of the substrate. As described in more detail below, the cavity in the substrate can reduce the parts required for the optical socket or simplify processing compared to alternative approaches, among other example advantages.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicates via an embedded bridge in a package substrate and an integrated circuit package attached to a printed circuit board that send signals to or receives signals from other integrated circuit packages or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “an implementation,” “an instance,” and the like may include features, structures, or characteristics, but not every embodiment necessarily includes the particular features, structures, or characteristics.

Some implementations may have some, all, or none of the features described for other implementations. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

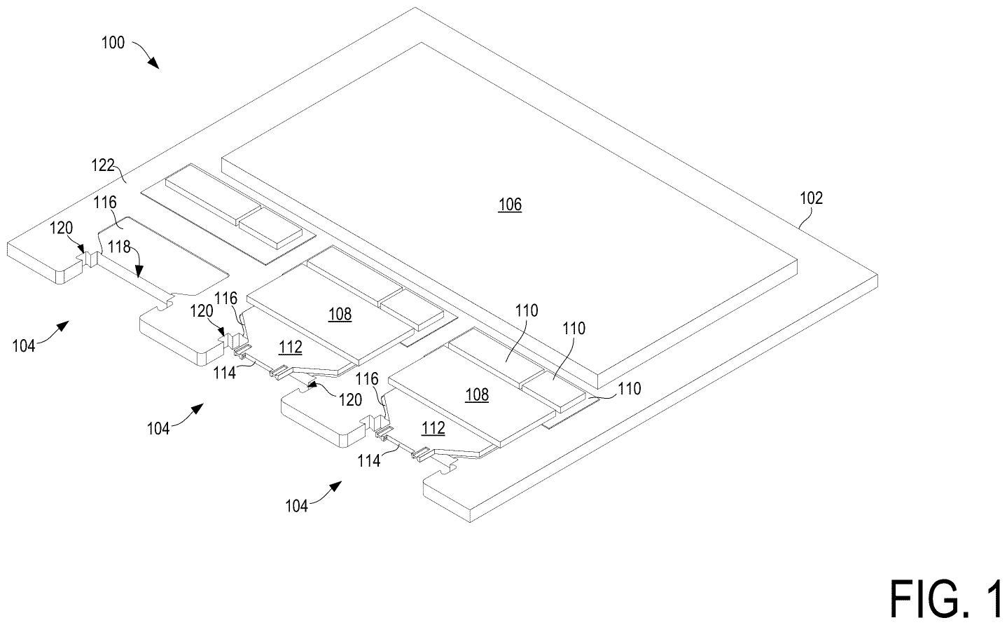

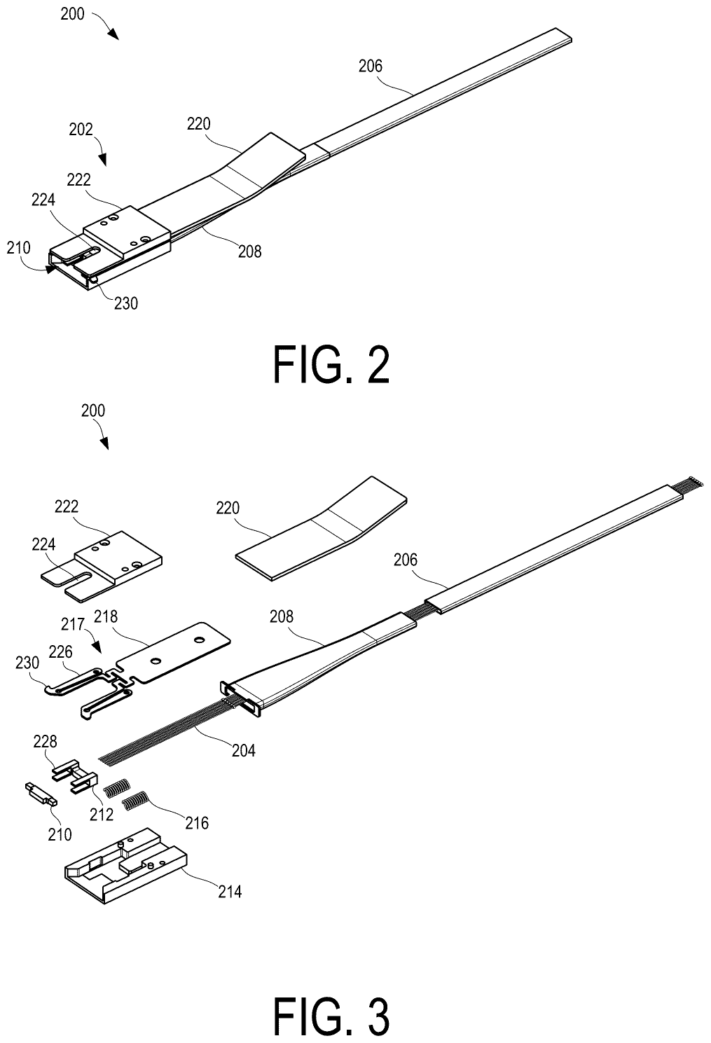

Referring now to FIG. 1, in one example, an integrated circuit package 100 includes a substrate 102, one or more optical sockets 104, and an electrical integrated circuit (EIC) die 106. In the illustrative embodiment, the optical sockets 104 are formed from the substrate 102 and an optical coupler interposer 112. The interposer 112 has a face 114 in which the ends of one or more waveguides are positioned. When the optical plug 202 (see FIG. 2) is mated with the optical socket 104, the optical fibers 204 of the optical plug 202 are lined up with the waveguides in the interposer 112 (e.g., to within less than one micrometer).

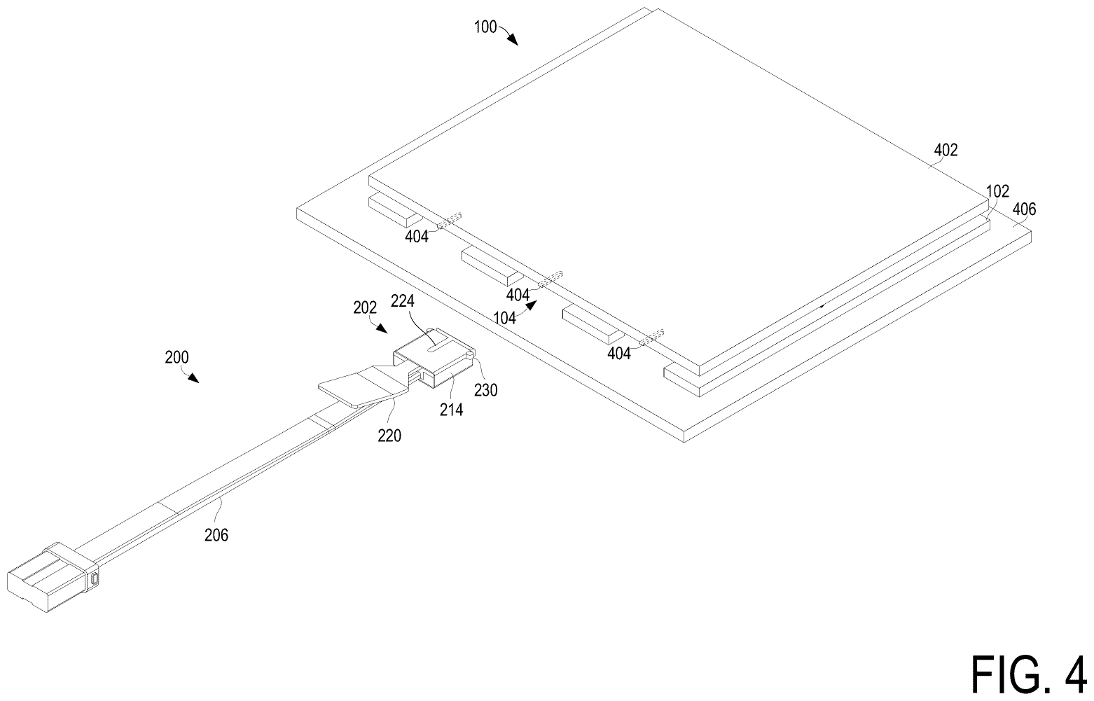

In the illustrative embodiment, the optical socket 104 is at least partially defined by a cavity 118 defined in the substrate 102. The illustrative cavity 118 is cut all the way through the substrate 102. The sidewalls of the cavity 118 define coarse lateral alignment features for the optical plug 202. The optical plug 202 can be coarsely aligned vertically by a lid 402 and another substrate 406, as described below in more detail in regard to FIG. 4, among other example features and implementations.

In some example implementations, The cavity 118 may include indents 120 that act as latching features. The indents 120 extend from the sidewalls of the cavity 118 further inward into the substrate 102. Protrusions 230 of the optical plug 202 can lock into position in the indents 120, preventing the optical plug 202 from being removed. Further, in some implementations, the interposer 112 is positioned on a shelf 116 that is slightly recessed from a top surface 122 of the substrate 102. The shelf 116 may position the interposer 112 at a desired height relative to other components, such as the substrate 102, the lid 402, the plug 202, etc. The shelf 116 may have any suitable depth, such as 0-250 micrometers.

Continuing with the example of FIG. 1, a photonic integrated circuit (PIC) die 108 is coupled with the optical interposer 112. In the illustrative embodiment, waveguides in the interposer 112 can carry light between the optical fibers 204 of the optical plug 202 and the PIC dies 108. The substrate 102 may support several additional integrated circuit dies 110, which may be PIC dies, EIC dies, or a combination of both. The additional integrated circuit dies 100 may facilitate communication, power delivery, and other suitable connections between the PIC dies 108 and the EIC die 106, among other example components.

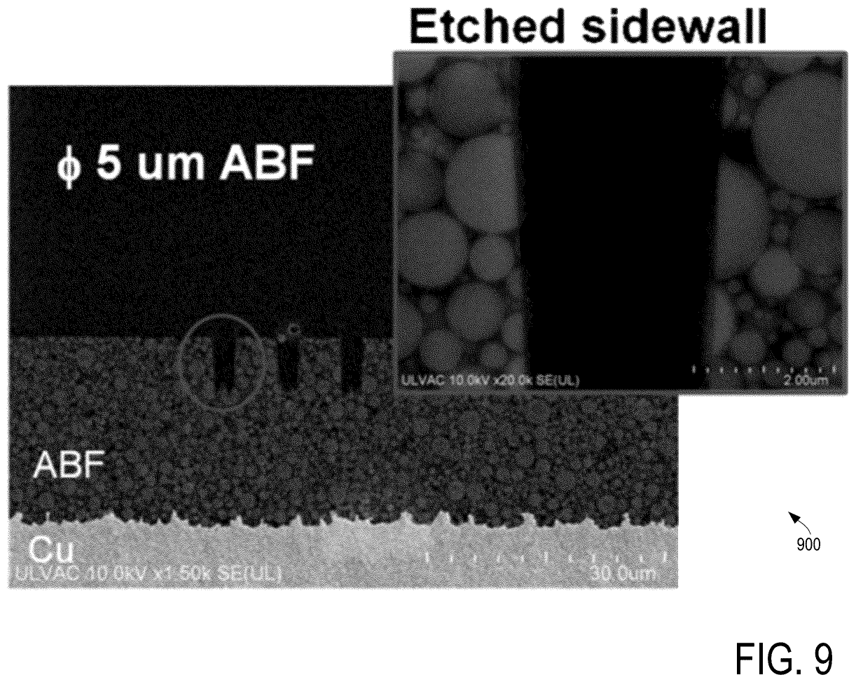

In one alternative example, additional components may be coupled to the substrate 102 to form part of the optical socket 104, such as part of the optical socket 104 to provide coarse lateral alignment and/or features to retain the optical plug 202 by mating with the protrusions 230. By forming part of the optical socket 104 from the substrate 102 itself, such an additional component can be removed. In another alternative approach, the substrate 102 can extend partially from the top surface 122 but not extend all the way through the substrate 102 to a bottom surface. Such an approach can provide similar coarse alignment features as the cavity 118. However, extending the cavity 118 all the way through the substrate 102 can simplify processing steps to form the cavity 118, reducing the cost and improving yield. Additionally, the shelf 116 can both provide flexibility in vertical positioning of the optical interposer 112 and can be formed with relatively simple processing steps, as described below in more detail in regard to the example technique discussed in association with FIG. 9.

The illustrative substrate 102 may be any suitable substrate, such as glass, silicon, ceramic, a circuit board, etc. In some embodiments, the substrate 102 is a circuit board made from any suitable material, such as ceramic, glass, and/or organic-based materials with fiberglass and resin, such as FR-4. In some embodiments, the substrate 102 is formed from or otherwise includes bismaleimide-triazine (BT) resin. The substrate 102 may have any suitable length or width, such as 10-500 millimeters. The substrate 102 may have any suitable thickness, such as 0.2-5 millimeters. The substrate 102 may support additional components besides those shown in FIG. 1, such as resistors, capacitors, other integrated circuit dies, power electronics, traces, etc.

In some implementations, the interposer 112 may be formed partially or wholly from silicon oxide glass. In other implementations, the interposer 112 may be made of any suitable material that may be crystalline, non-crystalline, amorphous, etc., such as fused silicon, borosilicate, sapphire, yttrium aluminum garnet, etc. The interposer 112 may be, e.g., aluminosilicate glass, borosilicate glass, alumino-borosilicate glass, silica, fused silica. The interposer 112 may include one or more additives, such as Al2O3, B2O3, MgO, CaO, SrO, BaO, SnO2, Na2O, K2O, SrO, P2O3, ZrO2, Li2O, Ti, and Zn. The glass interposer 112 may comprise silicon and oxygen, as well as any one or more of aluminum, boron, magnesium, calcium, barium, tin, sodium, potassium, strontium, phosphorus, zirconium, lithium, titanium, and zinc. The interposer 112 may include at least 20-40 percent silicon by weight, at least 20-40 percent oxygen by weight, and at least 5 percent aluminum by weight. For example, some embodiments of the interposer 112 may include, e.g., at least 20-23 percent silicon and at least 20-26 percent oxygen by weight. The interposer 112 may have any suitable length or width, such as 10-500 millimeters. The interposer 112 may have any suitable thickness, such as 0.2-5 millimeters. The material selected for the interposer may be based on the material of the optical fibers used in the optical plug to facilitate the efficient transmission of photon signals between the PIC and the cable through the interposer 112.

The interposer 112 may route light between the optical plug 202 and the PIC dies 108 using waveguides defined in the interposer 112. The waveguides may be routed in any suitable manner, including in three dimensions, allowing for flexible layouts. The interposer 112 may include optical elements such as fan outs, splitters, couplers, combiners, filters, etc. The integrated circuit package 100 may include any suitable number of interposers 112 and optical sockets 104, such as 1-64 or more. The PIC die 108 may be made of any suitable material, such as silicon. In the illustrative embodiment, waveguides are defined in the PIC die 108 that interface with waveguides defined in the interposer 112 to transfer light to or from the PIC die 108. In an illustrative embodiment, waveguides in the PIC die 108 may be silicon waveguides embedded in silicon oxide cladding. The PIC dies 108 may include any suitable number of waveguides, such as 1-1,024.

The PIC die 108 is configured to generate, detect, and/or manipulate light. The PIC die 108 may include active or passive optical elements such as splitters, couplers, filters, optical amplifiers, lasers, photodetectors, modulators, etc. The PIC die 108 may have electrical connections to the substrate 102 and/or the EIC die 106, such as for power delivery, sending and receiving data, and/or the like. The EIC die 106 may include any suitable electronic integrated circuit package, such as resistors, capacitors, inductors, transistors, etc. The EIC die 106 may include any suitable analog and/or digital circuitry, such as a processor, a memory, an application-specific integrated circuit (ASIC), a field-programmable gate array (FPGA), etc. In some embodiments, the integrated circuit package 100 may be embodied as a router, a switch, a network interface controller, and/or the like. In such embodiments, the EIC die 106 may include network interface controller circuitry to process, parse, route, etc., network packets sent and received by the integrated circuit package 100 through the optical cable 200.

Referring now to FIGS. 2 and 3, diagrams are shown of an example optical cable 200, which may be adapted to attach to a package via optical sockets, such as discussed and shown in the example of FIG. 1. In one example, an optical cable 200 includes one or more optical fibers 204 in a sheath 206 connected to an optical plug 202. FIG. 2 shows an assembled optical cable 200, and FIG. 3 shows a disassembled, or exploded, view of the optical cable 200, showing several of the parts of the optical cable. For instance, a strain relief 208 may be positioned between the sheath 206 and the optical plug 202. In the illustrative embodiment, the optical fibers 204 are free to move inside the strain relief 208, providing some slack in the optical fibers 204 and allowing the ferrule 210 to move relative to the strain relief 208. When assembled, the optical fibers 204 extend through fiber holes in the ferrule 210, terminating at an end face of the ferrule 210. A ferrule holder 212 holds the ferrule 210 loosely in place. Housing 214 holds the ferrule 210 and the ferrule holder 212. A housing cover 222 keeps the ferrule 210 and ferrule holder 212 within the housing 214. In the illustrative embodiment, springs 216 apply a force on the ferrule holder 212 and the ferrule 210. In use, as the plug 202 is mated with an optical socket 104, the springs 216 apply a force on the ferrule 210, pressing it against the optical socket, ensuring the ferrule 210 is in contact with the optical socket.

In some implementations, a retention mechanism 217 may also be provided within the housing 214. As the plug 202 is plugged into a socket, protrusions 230 of a spring clip 226 engage with the indents 120 of the socket 104, securing the optical plug 202 in place. Pulling on tab 218 of the retention mechanism 217 will pull the protrusions 230 of the spring clip 226 inward, freeing the plug 202 from the socket. Tab cover 220 can be attached to the tab 218 to allow a user to pull on the retention mechanism 217 more easily. In some embodiments, the retention mechanism 217 may press the ferrule 210 against the optical socket instead of or in addition to the springs 216. In some implementations, the housing cover 222 includes a slot 224, which can be used to both coarsely align the plug 202 as well as act as an orientation key, preventing the optical plug 202 from being inserted upside down. The slot 224 may interface with an element of the socket (e.g., rib 404 shown in FIG. 4). In addition to or as an alternative to the housing cover, in some embodiments, the optical plug 202 may include a sleeve surrounding the housing 214. The sleeve may contain the components of the optical plug 202 while allowing for servicing by removal of the sleeve.

It should be appreciated that, in some implementations, the ferrule holder 212 and the ferrule 210 can move within the housing 214 and that the ferrule 210 can move within the ferrule holder 212. As such, as the plug 202 is inserted into a socket, the ferrule holder 212 can move relative to the housing 214 to more precisely align the ferrule holder 212, and then the ferrule 210 can move relative to the ferrule holder 212 to more precisely align the ferrule 210 to ensure quality optical signal transmission from the end face of the ferrule to the interposer of the optical socket. The ferrule holder 212 may be aligned using alignment features 228. Further, fine alignment features may be provided on the ferrule 210 (such as discussed in more detail below) to provide finer-grained alignment, including at the micron level. Accordingly, the housing 214, the ferrule holder 212, and the ferrule 210 may provide multi-stage alignment to ensure quality optical signaling at the cable-socket interface.

An optical cable 200 may include any suitable number of optical fibers (e.g., 1-32 fibers). The optical fibers 204 may be arranged at the ferrule 210 in a one- or two-dimensional array. The illustrative optical fibers 204 are made out of glass and can carry light at any suitable wavelength (e.g., such as 400-2,000 nanometers). In the illustrative embodiment, the optical fibers 204 may support light in the C-band, O-band, L-band, S-band, etc. In other embodiments, the optical fibers 204 may be made out of a different material.

Referring now to FIG. 4, a diagram 400 is shown illustrating a computing device including integrated circuit component 100, which may be mounted to one or more other components, such as a substrate 406. The substrate 406 may be, e.g., a motherboard, another circuit board connecting the integrated circuit package 100 with other components, a housing, etc. The substrate 406 may be a similar or the same material as the substrate 102. In some implementations, integrated circuit package 100 may include a lid 402 or other physical guide. The lid 402 or guide may provide coarse alignment for the plug 202. The lid 402 may have a rib 404 that forms part of the socket 104. The rib 404 may align with a slot 224 defined in the optical plug 202. The rib 404 and slot 224 may establish a keying that prevents the optical plug 202 from being inserted upside down, among other example benefits. In some implementations, the computing device including integrated circuit component 100 may implement a server rack or sled, a set top box, personal computer, smart appliance, a display, or other computing device, which may advantageously utilize optical signaling, among other examples.

Traditional optical connector ferrules manufactured using high volume manufacturing (HVM) techniques are made from moldable plastics with manufacturing tolerances (e.g., greater than 50 μm) that are unable to meet the high precision tolerance requirements (e.g., less than 1 μm) for passive fine alignment to co-packaged optics (CPO) optical engines (e.g., such as an on-package PIC). Additionally, the moldable plastics used in traditional optical connector ferrules have coefficients of thermal expansion (CTEs) much larger (e.g., ˜50 parts per million per Celsius degree (ppm/C)) than that of the glass or silicon (e.g., CTE of ˜5 ppm/C) used for optical socket components (e.g., waveguides, interposers, etc.). This CTE mismatch may lead to misalignment and inefficient optical coupling between ferrules and the Si/glass waveguides (WGs) in CPO optical engines, for instance, while the system is at operating temperature.

To address these issues, traditional solutions have involved permanently attaching optical fibers to v-grooves provided in or at the interface of a PIC. However, permanent attachment of optical fibers to v-grooves is not HVM-friendly (e.g., slow throughput, difficult handling of assembly in fab equipment, etc.) and does not allow for replacement of bad optical fibers or rework without involving the replacement of the entire CPO system (e.g., when a fiber ribbon breaks, which may occur due to the dangling of fiber cables during manufacture, etc.). Materials may be selected for a ferrule (e.g., 210) to be included in an optical plug (e.g., 202) with a CTE that is matched or substantially similar to the CTE of the interposer (e.g., 112), waveguide, or other portion of an optical socket to which the ferrule is to interface with to allow photon data to be beamed through to the PIC. While materials such as glass or ceramics may be utilized to construct a ferrule with CTE suitably matched to the optical socket, such materials may also not lend themselves well to producing precision features using high volume manufacturing. For instance, the construction of ferrules from glass or ceramics may involve the development and use of molding or casting. Standard molding and casting may be limited in its precision. For example, it may be desirable to include fine alignment features on the ferrule at a level of precision (e.g., sub-micron) that is beyond the capabilities of traditional molding and casting techniques. Further, while fine alignment features may be attempted to be added to molded glass or ceramic ferrules (e.g., through laser assisted wet etching), the fragility of glass and ceramics makes breakage common when additional processing is applied. Fine alignment features may enable higher-performing optical connections, among other example advantages and issues.

In an improved solution, high volume silicon manufacturing techniques and fabrication equipment, such as used in the manufacturing of substrate and packaging materials, may be leveraged to manufacture high-precision ferrule devices. Low-CTE buildup dielectric materials may be utilized to form the ferrule device. High precision manufacturing techniques (e.g., dry etch, wet etch, laser, etc.) may be utilized to form optical plug ferrules with fine, high-precision passive alignment features from these low-CTE materials, which may be suitably CTE-matched to materials in a corresponding CPO socket, among other example features and advantages. The degree to which CTE is “matched” may be based on the tolerances defined for the particular application (e.g., to what degree an inexact or merely substantial matching is allowed). For instance, a matched CTE may allow for substantial matching of CTE values, such as matching within plus/minus 5 ppm/C of a target CTE (e.g., of a waveguide material). In other cases, the CTE matching may be more precise (e.g., within 5% or within 10% of a target CTE value), among other examples.

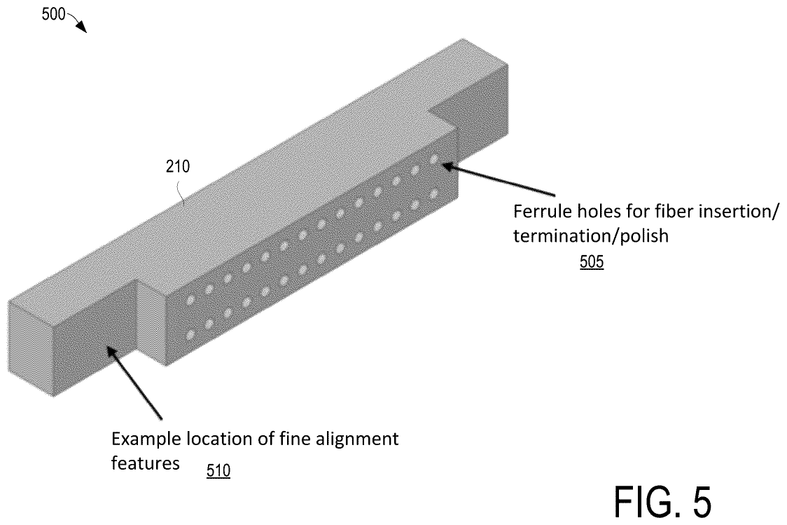

FIG. 5 is a diagram 500 illustrating an example ferrule device 210, such as a ferrule constructed from a layer of build-up dielectric material using high precision manufacturing techniques. The ferrule 210 may be included within a detachable optical connector for an optical cable, which is to align with waveguides within an optical socket (e.g., a CPO optical engine glass coupler of a PIC) to couple the cable to the CPO sub-system and enable photon signals to be transmitted/received between the CPO sub-system and another component via the optical connector. The ferrule 210 may include an array of ferrule holes (or “fiber holes”) (e.g., 505) through which the optical fibers of an optical fiber ribbon of an optical cable may be inserted. Optical photon signals may be emitted from the ferrule holes and directed into the waveguide (e.g., the waveguides of an interposer) of a CPO device (e.g., a PIC). To assist in aligning the ferrule holes with the waveguides in the socket of a CPO device, fine passive alignment features may be provided on the ferrule (e.g., at 510).

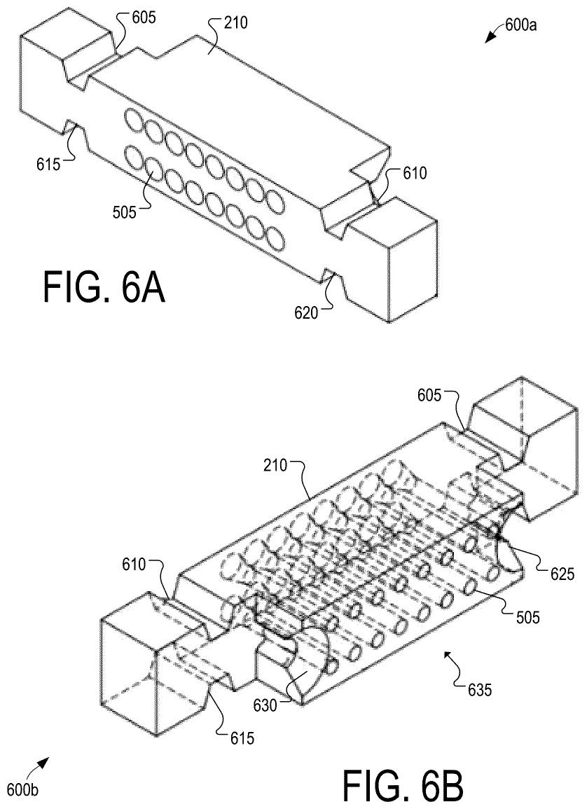

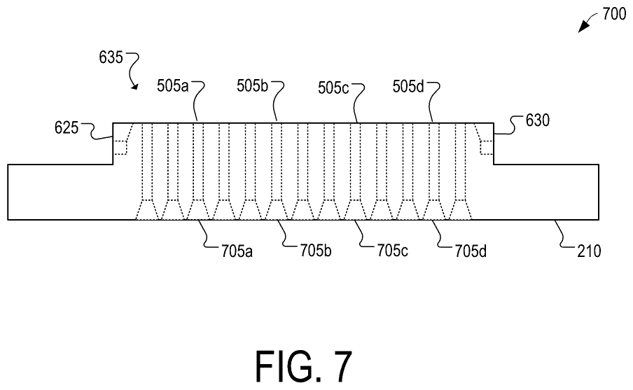

Turning to FIGS. 6A-6B, a more detailed implementation of an example ferrule 210 is presented. For instance, in FIG. 6A, a back view 600a of the ferrule is shown, including fiber holes (e.g., 505) through which the optical fibers are to be inserted. FIG. 6B shows a front view 600b of the ferrule including the side of the fiber holes (e.g., 505) where the ends of the optical fibers are exposed to send and receive optical signals to/from a CPO socket. In this example, medium alignment features (e.g., 605, 610, 615, 620) may be formed in the ferrule (e.g., through etching of a low-CTE buildup dielectric layer), together with fine alignment features (e.g., 510). For instance, high precision alignment features (e.g., notches, grooves, teeth, pins, dimples, etc.) may be formed within a (in this example, cylindrical) recess (e.g., 625, 630) provided near the front, or end, face of the ferrule. The recess and its alignment features may be adapted to mate with complimentary fine alignment features provided, for instance, on an end face 635 of a CPO socket interposer or other terminal. FIG. 7 shows a top view 700 of an example ferrule (e.g., similar to the ferrule show in the example of FIGS. 6A-6B). Broken lines illustrate cross-sectional channels, holes, or recesses within the ferrule as view from the top of the ferrule. For instance, ferrule holes (e.g., 505a-d) are shown. In some implementations, at the rear or back side of the ferrule, the ferrule holes may be constructed (e.g., through etching) to include tapered entries (e.g., 705a-d) to assist with the insertion of respective optical fibers into each one of the ferrule holes 505a-d. Further, recesses 625, 630 are shown at which fine alignment features may be formed (e.g., through a dry or wet etch process), among other examples.

As introduced above, low-CTE (e.g., ˜5 ppm/C) substrate/packaging build-up dielectric materials may be utilized, together with silicon fabrication equipment (e.g., etch and laser manufacturing equipment capable of patterning sub-micron fine alignment features) to realize high-precision, CTE-matched ferrule devices using efficient, HVM equipment and processes. Build-up dielectric materials may include liquid dielectrics (which may be cured into a solid layer) or dielectric films, which possess CTE similar to CPO socket waveguides to which the corresponding optical plug is to couple or connect to. In one example, an Ajinomoto Build-Up Films (ABF)-based film or layer may be utilized to form the build-up dielectric layer. In another example, a build-up dielectric (with 5 ppm/C) layer may be used, among other example materials and implementations.

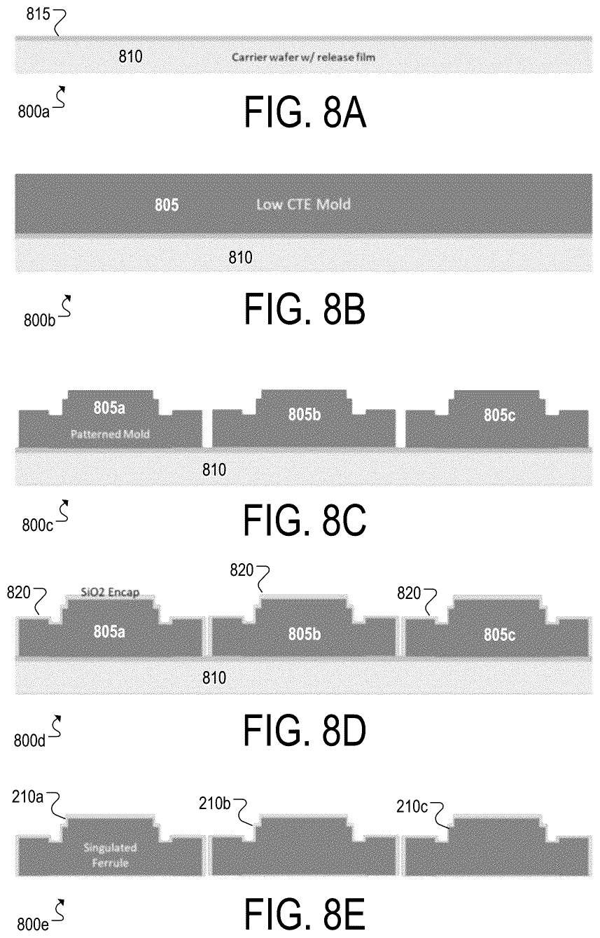

Turning to FIGS. 8A-8E, a series of diagrams 800a-e are shown illustrating an example process flow for forming a CTE-matched optical connector ferrule from a build-up dielectric layer (e.g., 805). For instance, a base carrier wafer or panel (e.g., 810) may be provided with a release layer (e.g., 815) deposited or otherwise provided thereon, as shown in FIG. 8A. As shown in FIG. 8B, a low-CTE build-up dielectric 805 may be deposited to a desired thickness (e.g., 1 mm) on the release layer 815. For instance, the build-up dielectric can be deposited on the base through lamination, spin-coating, slit coating, among other suitable techniques. In some cases, a curing step may be performed to form the solid dielectric layer and prepare the build-up dielectric for further processing.

Continuing with the example of FIGS. 8A-8E, as illustrated in FIG. 8C, subtractive manufacturing steps may be performed on the build-up dielectric layer 805 using various fabrication techniques. For instance, medium and fine alignment features may be patterned, as well as fiber holes (e.g., with tapering) in the build-up dielectric. For instance, patterning may be performed using one or a combination of fabrication techniques and steps, such as using one or a combination of laser, lithography, and etch processes. As an example, a lithography (or “litho”) step can utilize hard masks (e.g., metal), soft masks (e.g., photoresist), or shadow masks (e.g., through a frame above the dielectric surface) to pattern the features to be etched from the build-up dielectric. A dry (e.g., plasma) etch or wet etch may be utilized. Multiple patterning steps may be performed to form and achieve the various heights and contours of the ferrule. Turning to FIG. 9, images 900a-b are shown illustrating images of an example implementation, where a build-up dielectric layer (e.g., LES50, w/5 ppm/C) is deposited on a base layer. Features (e.g., 905, 910) are shown, which are formed through the use of laser and dry etch to create smooth sidewall features w/submicron roughness (e.g., between build-up-dielectric resin and silica fillers). Similarly precise features of varying dimensions and geometry may be formed to construct a high-precision ferrule (e.g., with fine alignment features).

In some implementations, while a low-CTE build-up dielectric may have a CTE that is sufficiently close to the CTE of the CPO waveguide material, the CTE-match between plug/ferrule and socket/waveguide may be improved by depositing an additional layer of low-CTE material on top of the patterned build-up dielectric ferrule structure. For instance, as illustrated in FIG. 8D, a layer of SiO2 glass or other CTE-matched material (e.g., Ti metal, etc.) may be deposited to encapsulate the build-up dielectric ferrule for further ferrule CTE control. For instance, the enhanced CTE layer (e.g., 820) may be deposited on the build-up dielectric ferrule layer 805 using deposition techniques such as physical vapor deposition (PVD), chemical vapor deposition (CVD), spin on glass, among other example techniques. The addition of the enhanced CTE layer (e.g., 820) may be optional in some implementations.

With the ferrule instances (e.g., 210a-210c) formed from the build-up dielectric layer 805, the ferrule elements 210a-c may be released from the base layer 810 (and release layer 815) to singulate the ferrule elements 210a-c. For instance, carrier release may be accomplished through thermal debonding, laser debonding, among other example techniques. In some cases, a dicing step or operation may be performed to assist with ferrule singulation (e.g., using a laser, saw, or other mechanism). Assembly of an optical connector element incorporating the ferrule may include the insertion of optical fibers into the fiber holes of the ferrule, together with additional assembly steps and processes to complete the optical connector element (e.g., plug, cable, etc.).

In some implementations, prior to release of the ferrule instances 210a-c, additionally processing may be performed to finish the ferrules, for instance, through additional subtractive processing, patterning, polishing, deposition steps, etc. For instance, a second carrier wafer (e.g., with release layer) may be attached to a top or front face of the ferrule and additional patterning may be performed on the bottom or backside of the ferrule. The second carrier wafer may then be released from the ferrule instances to singulate the ferrule instances, among other examples. In some implementations, additional processing (e.g., on the underside of the ferrule) may be performed following singulation, among other example approaches.

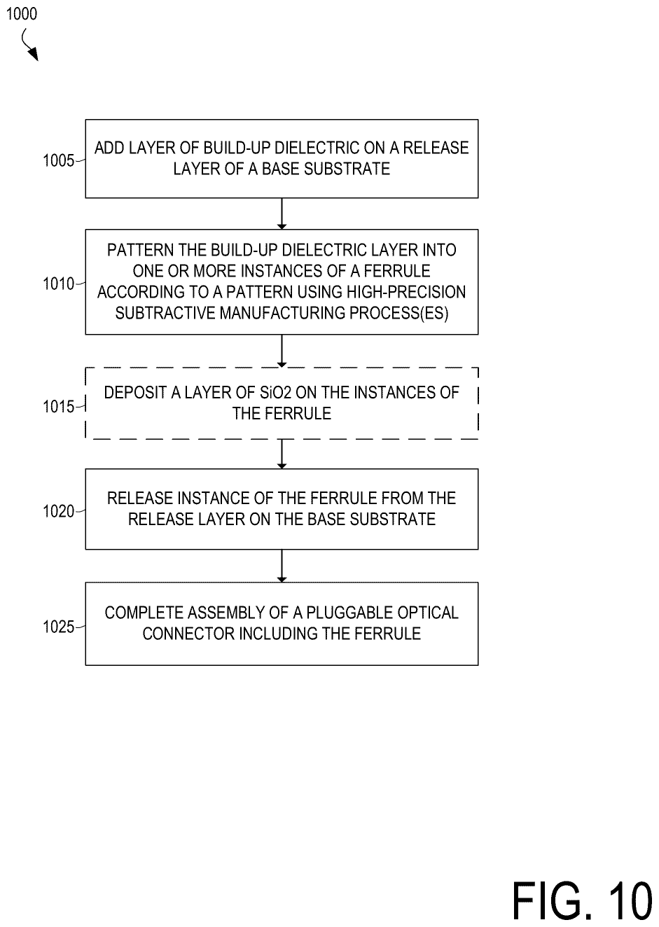

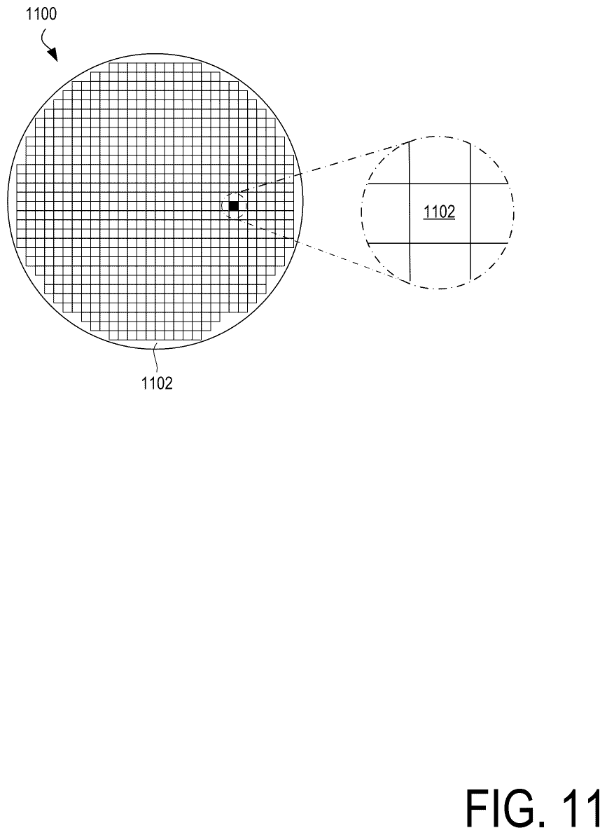

FIG. 10 is a flow diagram 1000 of an example technique for manufacturing an optical connector ferrule. For instance, a layer of build-up dielectric may be added 1005 to a carrier wafer or other base substrate (e.g., on top of a release layer provided on the substrate). The build-up dielectric layer may be laminated, slit coated, or otherwise added to or formed on top of the base substrate layer. The CTE characteristics of the selected build-up dielectric may be selected or engineered to achieve low-CTE characteristics and substantially match the CTE characteristics of a waveguide or interposer of a coordinating optical socket element (e.g., of a PIC). One or more subtractive processing phases may be applied to the solid build-up dielectric layer to pattern 1010 the dielectric layer into multiple ferrule elements with defined physical features, such as respective ferrule holes, medium and/or fine alignment features, etc. For instance, the dielectric layer may be patterned utilizing photo lithography (e.g., through use of a hard mask, soft mask, or shadow mask) and etching processes (e.g., dry etching, wet etching, etc.) or laser processes. In some cases, a combination of etching steps and/or laser cutting steps may be applied to subtract material from the dielectric layer to form the high-precision ferrule instances. Optionally, additional layers (e.g., CTE-matched SiO2 layers) may be deposited 1015 on the ferrule instances. With the ferrule instances patterned, a release process may be performed 1020 to release and singulate the individual ferrule instances from the release film on the base substrate. Additional assembly 1025 may be performed to complete an optical connector element or sub-component thereof that is to include respective ferrule instances, including the insertion of one or more (e.g., an array) of optical fibers into fiber holes formed (e.g., etched) into the build-up dielectric ferrule element.

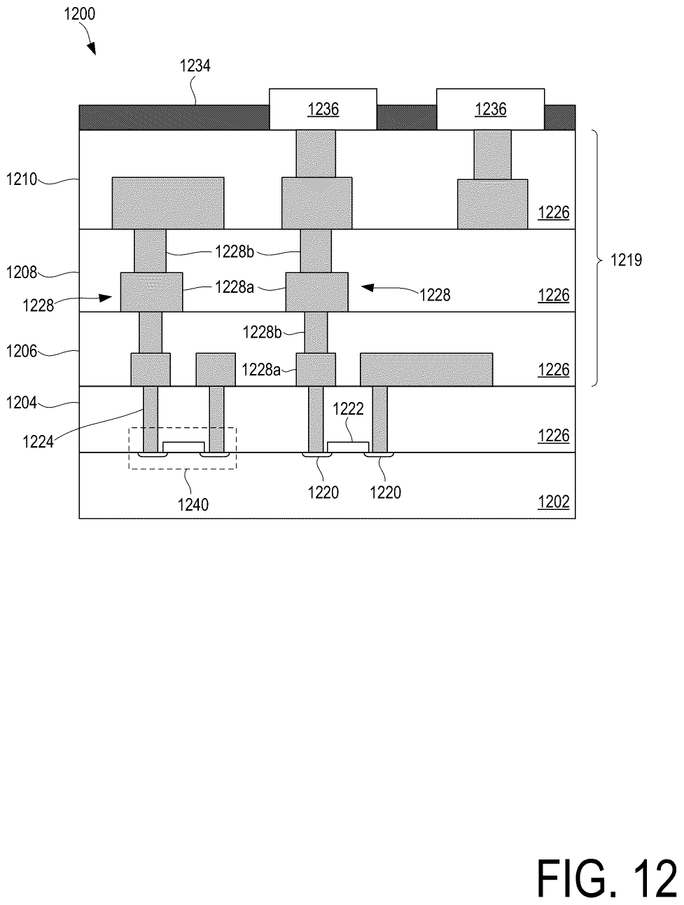

FIG. 11 is a top view of a wafer 1100 and dies 1102 that may be included in any of the integrated circuit packages 100 disclosed herein (e.g., as any suitable ones of the dies 106, 108, 110). The wafer 1100 may be composed of semiconductor material and may include one or more dies 1102 having integrated circuit structures formed on a surface of the wafer 1100. The individual dies 1102 may be a repeating unit of an integrated circuit product that includes any suitable integrated circuit. After the fabrication of the semiconductor product is complete, the wafer 1100 may undergo a singulation process in which the dies 1102 are separated from one another to provide discrete “chips” of the integrated circuit product. The die 1102 may be any of the dies 106, 108, 110 disclosed herein. The die 1102 may include one or more transistors (e.g., some of the transistors 1240 of FIG. 12, discussed below), supporting circuitry to route electrical signals to the transistors, passive components (e.g., signal traces, resistors, capacitors, or inductors), and/or any other integrated circuit components. In some embodiments, the wafer 1100 or the die 1102 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1102. For example, a memory array formed by multiple memory devices may be formed on a same die 1102 as a processor unit (e.g., the processor unit 1102 of FIG. 11) or other logic that is configured to store information in the memory devices or execute instructions stored in the memory array. Various ones of the integrated circuit packages 100 disclosed herein may be manufactured using a die-to-wafer assembly technique in which some dies 106, 108, 110 are attached to a wafer 1100 that include others of the dies 106, 108, 110, and the wafer 1100 is subsequently singulated.

FIG. 12 is a cross-sectional side view of an integrated circuit device 1200 that may be included in any of the integrated circuit packages 100 disclosed herein (e.g., in any of the dies 106, 108, 110). One or more of the integrated circuit devices 1200 may be included in one or more dies 1102 (FIG. 11). The integrated circuit device 1200 may be formed on a die substrate 1202 (e.g., the wafer 1100 of FIG. 11) and may be included in a die (e.g., the die 1102 of FIG. 11). The die substrate 1202 may be a semiconductor substrate composed of semiconductor material systems including, for example, n-type or p-type materials systems (or a combination of both). The die substrate 1202 may include, for example, a crystalline substrate formed using a bulk silicon or a silicon-on-insulator (SOI) substructure. In some embodiments, the die substrate 1202 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V. or IV may also be used to form the die substrate 1202. Although a few examples of materials from which the die substrate 1202 may be formed are described here, any material that may serve as a foundation for an integrated circuit device 1200 may be used. The die substrate 1202 may be part of a singulated die (e.g., the dies 1102 of FIG. 11) or a wafer (e.g., the wafer 1100 of FIG. 11).

The integrated circuit device 1200 may include one or more device layers 1204 disposed on the die substrate 1202. The device layer 1204 may include features of one or more transistors 1240 (e.g., metal oxide semiconductor field-effect transistors (MOSFETs)) formed on the die substrate 1202. The transistors 1240 may include, for example, one or more source and/or drain (S/D) regions 1220, a gate 1222 to control current flow between the S/D regions 1220, and one or more S/D contacts 1224 to route electrical signals to/from the S/D regions 1220. The transistors 1240 may include additional features not depicted for the sake of clarity, such as device isolation regions, gate contacts, and the like. The transistors 1240 are not limited to the type and configuration depicted in FIG. 12 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

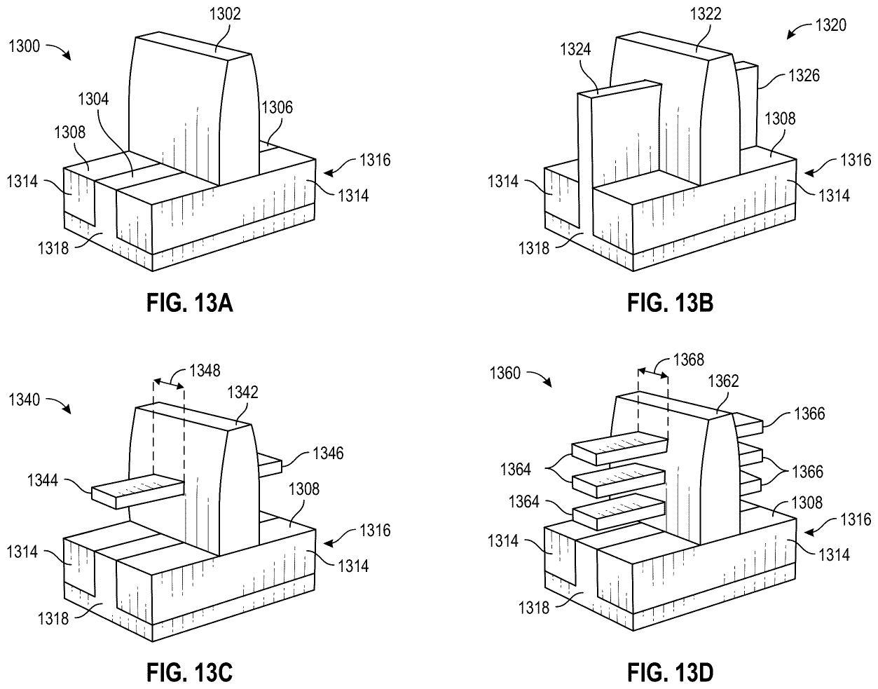

FIGS. 13A-13D are simplified perspective views of example planar, FinFET, gate-all-around, and stacked gate-all-around transistors. The transistors illustrated in FIGS. 13A-13D are formed on a substrate 1316 having a surface 1308. Isolation regions 1314 separate the source and drain regions of the transistors from other transistors and from a bulk region 1318 of the substrate 1316.

FIG. 13A is a perspective view of an example planar transistor 1300 comprising a gate 1302 that controls current flow between a source region 1304 and a drain region 1306. The transistor 1300 is planar in that the source region 1304 and the drain region 1306 are planar with respect to the substrate surface 1308.

FIG. 13B is a perspective view of an example FinFET transistor 1320 comprising a gate 1322 that controls current flow between a source region 1324 and a drain region 1326. The transistor 1320 is non-planar in that the source region 1324 and the drain region 1326 comprise “fins” that extend upwards from the substrate surface 1328. As the gate 1322 encompasses three sides of the semiconductor fin that extends from the source region 1324 to the drain region 1326, the transistor 1320 can be considered a tri-gate transistor. FIG. 13B illustrates one S/D fin extending through the gate 1322, but multiple S/D fins can extend through the gate of a FinFET transistor.

FIG. 13C is a perspective view of a gate-all-around (GAA) transistor 1340 comprising a gate 1342 that controls current flow between a source region 1344 and a drain region 1346. The transistor 1340 is non-planar in that the source region 1344 and the drain region 1346 are elevated from the substrate surface 1328.

FIG. 13D is a perspective view of a GAA transistor 1360 comprising a gate 1362 that controls current flow between multiple elevated source regions 1364 and multiple elevated drain regions 1366. The transistor 1360 is a stacked GAA transistor as the gate controls the flow of current between multiple elevated S/D regions stacked on top of each other. The transistors 1340 and 1360 are considered gate-all-around transistors as the gates encompass all sides of the semiconductor portions that extends from the source regions to the drain regions. The transistors 1340 and 1360 can alternatively be referred to as nanowire, nanosheet, or nanoribbon transistors depending on the width (e.g., widths 1348 and 1368 of transistors 1340 and 1360, respectively) of the semiconductor portions extending through the gate.

Returning to FIG. 12, a transistor 1240 may include a gate 1222 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1240 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1240 along the source-channel-drain direction, the gate electrode may consist of a U-shaped structure that includes a bottom portion substantially parallel to the surface of the die substrate 1202 and two sidewall portions that are substantially perpendicular to the top surface of the die substrate 1202. In other embodiments, at least one of the metal layers that form the gate electrode may simply be a planar layer that is substantially parallel to the top surface of the die substrate 1202 and does not include sidewall portions substantially perpendicular to the top surface of the die substrate 1202. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1220 may be formed within the die substrate 1202 adjacent to the gate 1222 of individual transistors 1240. The S/D regions 1220 may be formed using an implantation/diffusion process or an etching/deposition process, for example. In the former process, dopants such as boron, aluminum, antimony, phosphorous, or arsenic may be ion-implanted into the die substrate 1202 to form the S/D regions 1220. An annealing process that activates the dopants and causes them to diffuse farther into the die substrate 1202 may follow the ion-implantation process. In the latter process, the die substrate 1202 may first be etched to form recesses at the locations of the S/D regions 1220. An epitaxial deposition process may then be carried out to fill the recesses with material that is used to fabricate the S/D regions 1220. In some implementations, the S/D regions 1220 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1220 may be formed using one or more alternate semiconductor materials such as germanium or a group III-V material or alloy. In further embodiments, one or more layers of metal and/or metal alloys may be used to form the S/D regions 1220.

Electrical signals, such as power and/or input/output (I/O) signals, may be routed to and/or from the devices (e.g., transistors 1240) of the device layer 1204 through one or more interconnect layers disposed on the device layer 1204 (illustrated in FIG. 12 as interconnect layers 1206-1210). For example, electrically conductive features of the device layer 1204 (e.g., the gate 1222 and the S/D contacts 1224) may be electrically coupled with the interconnect structures 1228 of the interconnect layers 1206-1210. The one or more interconnect layers 1206-1210 may form a metallization stack (also referred to as an “ILD stack”) 1219 of the integrated circuit device 1200.

The interconnect structures 1228 may be arranged within the interconnect layers 1206-1210 to route electrical signals according to a wide variety of designs; in particular, the arrangement is not limited to the particular configuration of interconnect structures 1228 depicted in FIG. 12. Although a particular number of interconnect layers 1206-1210 is depicted in FIG. 12, embodiments of the present disclosure include integrated circuit devices having more or fewer interconnect layers than depicted.

In some embodiments, the interconnect structures 1228 may include lines 1228a and/or vias 1228b filled with an electrically conductive material such as a metal. The lines 1228a may be arranged to route electrical signals in a direction of a plane that is substantially parallel with a surface of the die substrate 1202 upon which the device layer 1204 is formed. For example, the lines 1228a may route electrical signals in a direction in and out of the page and/or in a direction across the page. The vias 1228b may be arranged to route electrical signals in a direction of a plane that is substantially perpendicular to the surface of the die substrate 1202 upon which the device layer 1204 is formed. In some embodiments, the vias 1228b may electrically couple lines 1228a of different interconnect layers 1206-1210 together.

The interconnect layers 1206-1210 may include a dielectric material 1226 disposed between the interconnect structures 1228, as shown in FIG. 12. In some embodiments, dielectric material 1226 disposed between the interconnect structures 1228 in different ones of the interconnect layers 1206-1210 may have different compositions; in other embodiments, the composition of the dielectric material 1226 between different interconnect layers 1206-1210 may be the same. The device layer 1204 may include a dielectric material 1226 disposed between the transistors 1240 and a bottom layer of the metallization stack as well. The dielectric material 1226 included in the device layer 1204 may have a different composition than the dielectric material 1226 included in the interconnect layers 1206-1210; in other embodiments, the composition of the dielectric material 1226 in the device layer 1204 may be the same as a dielectric material 1226 included in any one of the interconnect layers 1206-1210.

A first interconnect layer 1206 (referred to as Metal 1 or “M1”) may be formed directly on the device layer 1204. In some embodiments, the first interconnect layer 1206 may include lines 1228a and/or vias 1228b, as shown. The lines 1228a of the first interconnect layer 1206 may be coupled with contacts (e.g., the S/D contacts 1224) of the device layer 1204. The vias 1228b of the first interconnect layer 1206 may be coupled with the lines 1228a of a second interconnect layer 1208.

The second interconnect layer 1208 (referred to as Metal 2 or “M2”) may be formed directly on the first interconnect layer 1206. In some embodiments, the second interconnect layer 1208 may include via 1228b to couple the lines 1228 of the second interconnect layer 1208 with the lines 1228a of a third interconnect layer 1210. Although the lines 1228a and the vias 1228b are structurally delineated with a line within individual interconnect layers for the sake of clarity, the lines 1228a and the vias 1228b may be structurally and/or materially contiguous (e.g., simultaneously filled during a dual-damascene process) in some embodiments.

The third interconnect layer 1210 (referred to as Metal 3 or “M3”) (and additional interconnect layers, as desired) may be formed in succession on the second interconnect layer 1208 according to similar techniques and configurations described in connection with the second interconnect layer 1208 or the first interconnect layer 1206. In some embodiments, the interconnect layers that are “higher up” in the metallization stack 1219 in the integrated circuit device 1200 (i.e., farther away from the device layer 1204) may be thicker that the interconnect layers that are lower in the metallization stack 1219, with lines 1228a and vias 1228b in the higher interconnect layers being thicker than those in the lower interconnect layers.

The integrated circuit device 1200 may include a solder resist material 1234 (e.g., polyimide or similar material) and one or more conductive contacts 1236 formed on the interconnect layers 1206-1210. In FIG. 12, the conductive contacts 1236 are illustrated as taking the form of bond pads. The conductive contacts 1236 may be electrically coupled with the interconnect structures 1228 and configured to route the electrical signals of the transistor(s) 1240 to external devices. For example, solder bonds may be formed on the one or more conductive contacts 1236 to mechanically and/or electrically couple an integrated circuit die including the integrated circuit device 1200 with another component (e.g., a printed circuit board). The integrated circuit device 1200 may include additional or alternate structures to route the electrical signals from the interconnect layers 1206-1210; for example, the conductive contacts 1236 may include other analogous features (e.g., posts) that route the electrical signals to external components.

In some embodiments in which the integrated circuit device 1200 is a double-sided die, the integrated circuit device 1200 may include another metallization stack (not shown) on the opposite side of the device layer(s) 1204. This metallization stack may include multiple interconnect layers as discussed above with reference to the interconnect layers 1206-1210, to provide conductive pathways (e.g., including conductive lines and vias) between the device layer(s) 1204 and additional conductive contacts (not shown) on the opposite side of the integrated circuit device 1200 from the conductive contacts 1236.

In other embodiments in which the integrated circuit device 1200 is a double-sided die, the integrated circuit device 1200 may include one or more through silicon vias (TSVs) through the die substrate 1202; these TSVs may make contact with the device layer(s) 1204, and may provide conductive pathways between the device layer(s) 1204 and additional conductive contacts (not shown) on the opposite side of the integrated circuit device 1200 from the conductive contacts 1236. In some embodiments, TSVs extending through the substrate can be used for routing power and ground signals from conductive contacts on the opposite side of the integrated circuit device 1200 from the conductive contacts 1236 to the transistors 1240 and any other components integrated into the die 1200, and the metallization stack 1219 can be used to route I/O signals from the conductive contacts 1236 to transistors 1240 and any other components integrated into the die 1200.

Multiple integrated circuit devices 1200 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit dic. Conductive contacts can provide additional connections between adjacent integrated circuit dies in the stack. In some embodiments, the conductive contacts can be fine-pitch solder bumps (microbumps).

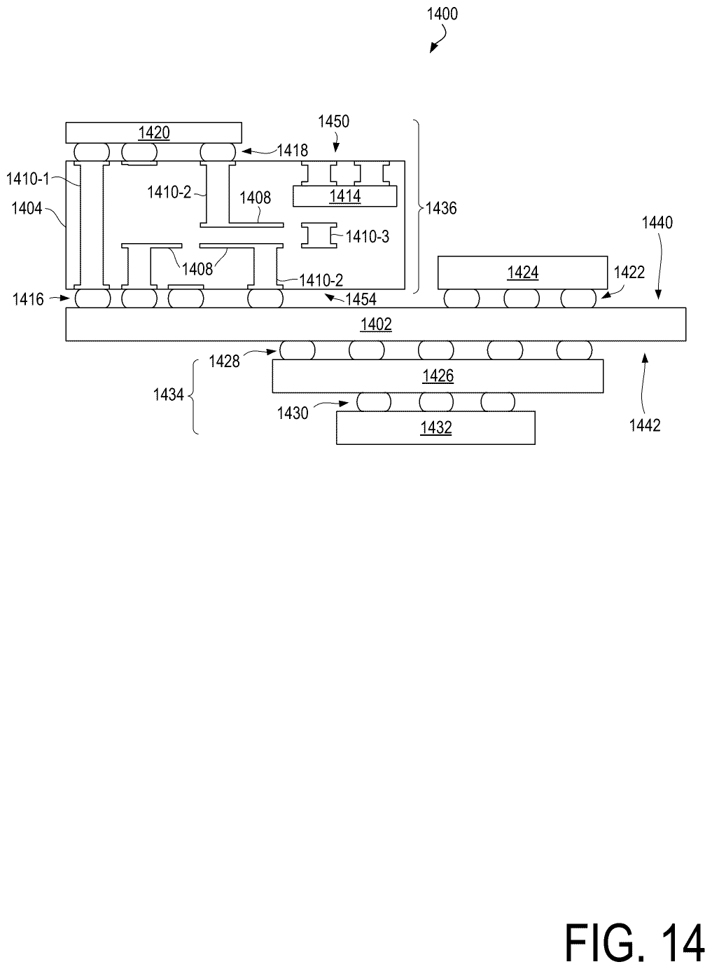

FIG. 14 is a cross-sectional side view of an integrated circuit device assembly 1400 that may include any of the integrated circuit packages 100 disclosed herein. In some embodiments, the integrated circuit device assembly 1400 may be an integrated circuit packages 100. The integrated circuit device assembly 1400 includes a number of components disposed on a circuit board 1402 (which may be a motherboard, system board, mainboard, etc.). The integrated circuit device assembly 1400 includes components disposed on a first face 1440 of the circuit board 1402 and an opposing second face 1442 of the circuit board 1402; generally, components may be disposed on one or both faces 1440 and 1442. Any of the integrated circuit components discussed below with reference to the integrated circuit device assembly 1400 may take the form of any suitable ones of the embodiments of the integrated circuit packages 100 disclosed herein.

In some embodiments, the circuit board 1402 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1402. In other embodiments, the circuit board 1402 may be a non-PCB substrate. In some embodiments the circuit board 1402 may be, for example, the substrate 102 or substrate 406. The integrated circuit device assembly 1400 illustrated in FIG. 14 includes a package-on-interposer structure 1436 coupled to the first face 1440 of the circuit board 1402 by coupling components 1416. The coupling components 1416 may electrically and mechanically couple the package-on-interposer structure 1436 to the circuit board 1402, and may include solder balls (as shown in FIG. 14), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1436 may include an integrated circuit component 1420 coupled to an interposer 1404 by coupling components 1418. The coupling components 1418 may take any suitable form for the application, such as the forms discussed above with reference to the coupling components 1416. Although a single integrated circuit component 1420 is shown in FIG. 14, multiple integrated circuit components may be coupled to the interposer 1404; indeed, additional interposers may be coupled to the interposer 1404. The interposer 1404 may provide an intervening substrate used to bridge the circuit board 1402 and the integrated circuit component 1420.

The integrated circuit component 1420 may be a packaged or unpacked integrated circuit product that includes one or more integrated circuit dies (e.g., the die 1102 of FIG. 11, the integrated circuit device 1200 of FIG. 12) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1420, a single monolithic integrated circuit die comprises solder bumps attached to contacts on the die. The solder bumps allow the die to be directly attached to the interposer 1404. The integrated circuit component 1420 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1420 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1420 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1420 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1404 may spread connections to a wider pitch or reroute a connection to a different connection. For example, the interposer 1404 may couple the integrated circuit component 1420 to a set of ball grid array (BGA) conductive contacts of the coupling components 1416 for coupling to the circuit board 1402. In the embodiment illustrated in FIG. 14, the integrated circuit component 1420 and the circuit board 1402 are attached to opposing sides of the interposer 1404; in other embodiments, the integrated circuit component 1420 and the circuit board 1402 may be attached to a same side of the interposer 1404. In some embodiments, three or more components may be interconnected by way of the interposer 1404.

In some embodiments, the interposer 1404 may be formed as a PCB, including multiple metal layers separated from one another by layers of dielectric material and interconnected by electrically conductive vias. In some embodiments, the interposer 1404 may be formed of an epoxy resin, a fiberglass-reinforced epoxy resin, an epoxy resin with inorganic fillers, a ceramic material, or a polymer material such as polyimide. In some embodiments, the interposer 1404 may be formed of alternate rigid or flexible materials that may include the same materials described above for use in a semiconductor substrate, such as silicon, germanium, and other group III-V and group IV materials. The interposer 1404 may include metal interconnects 1408 and vias 1410, including but not limited to through hole vias 1410-1 (that extend from a first face 1450 of the interposer 1404 to a second face 1454 of the interposer 1404), blind vias 1410-2 (that extend from the first or second faces 1450 or 1454 of the interposer 1404 to an internal metal layer), and buried vias 1410-3 (that connect internal metal layers).

In some embodiments, the interposer 1404 can comprise a silicon interposer. Through silicon vias (TSV) extending through the silicon interposer can connect connections on a first face of a silicon interposer to an opposing second face of the silicon interposer. In some embodiments, an interposer 1404 comprising a silicon interposer can further comprise one or more routing layers to route connections on a first face of the interposer 1404 to an opposing second face of the interposer 1404.

The interposer 1404 may further include embedded devices 1414, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1404. The package-on-interposer structure 1436 may take the form of any of the package-on-interposer structures known in the art.

The integrated circuit device assembly 1400 may include an integrated circuit component 1424 coupled to the first face 1440 of the circuit board 1402 by coupling components 1422. The coupling components 1422 may take the form of any of the embodiments discussed above with reference to the coupling components 1416, and the integrated circuit component 1424 may take the form of any of the embodiments discussed above with reference to the integrated circuit component 1420.

The integrated circuit device assembly 1400 illustrated in FIG. 14 includes a package-on-package structure 1434 coupled to the second face 1442 of the circuit board 1402 by coupling components 1428. The package-on-package structure 1434 may include an integrated circuit component 1426 and an integrated circuit component 1432 coupled together by coupling components 1430 such that the integrated circuit component 1426 is disposed between the circuit board 1402 and the integrated circuit component 1432. The coupling components 1428 and 1430 may take the form of any of the embodiments of the coupling components 1416 discussed above, and the integrated circuit components 1426 and 1432 may take the form of any of the embodiments of the integrated circuit component 1420 discussed above. The package-on-package structure 1434 may be configured in accordance with any of the package-on-package structures known in the art.

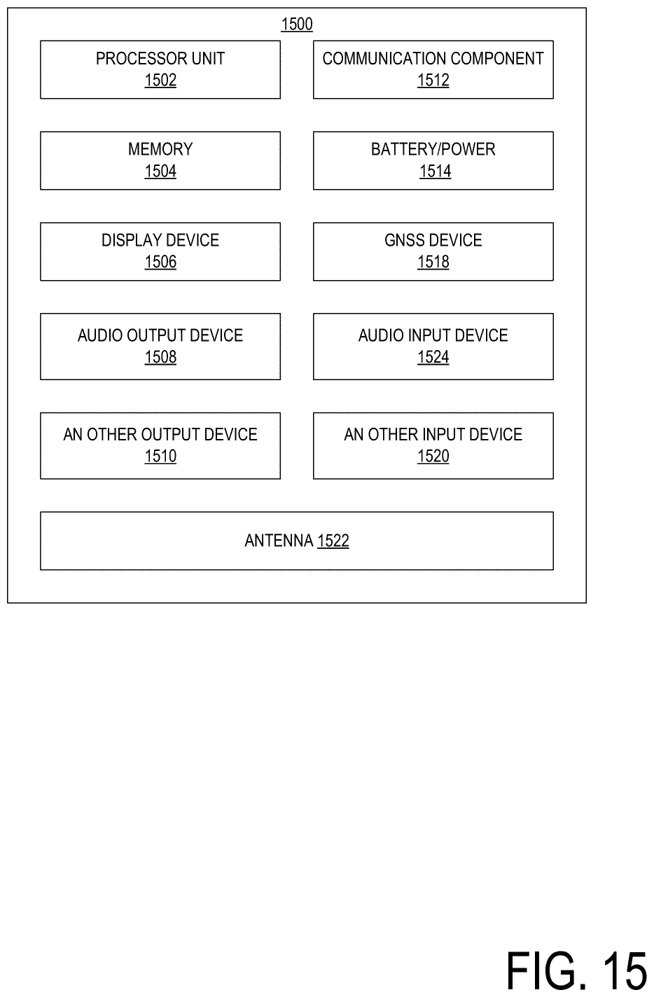

FIG. 15 is a block diagram of an example electrical device 1500 that may include one or more of the integrated circuit packages 100 disclosed herein. For example, any suitable ones of the components of the electrical device 1500 may include one or more of the integrated circuit device assemblies 1400, integrated circuit components 1420, integrated circuit devices 1200, or integrated circuit dies 1502 disclosed herein, and may be arranged in any of the integrated circuit packages 100 disclosed herein. A number of components are illustrated in FIG. 15 as included in the electrical device 1500, but any one or more of these components may be omitted or duplicated, as suitable for the application. In some embodiments, some or all of the components included in the electrical device 1500 may be attached to one or more motherboards mainboards, or system boards. In some embodiments, one or more of these components are fabricated onto a single system-on-a-chip (SoC) die.

Additionally, in various embodiments, the electrical device 1500 may not include one or more of the components illustrated in FIG. 15, but the electrical device 1500 may include interface circuitry for coupling to the one or more components. For example, the electrical device 1500 may not include a display device 1506, but may include display device interface circuitry (e.g., a connector and driver circuitry) to which a display device 1506 may be coupled. In another set of examples, the electrical device 1500 may not include an audio input device 1524 or an audio output device 1508, but may include audio input or output device interface circuitry (e.g., connectors and supporting circuitry) to which an audio input device 1524 or audio output device 1508 may be coupled.

The electrical device 1500 may include one or more processor units 1502 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1502 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1500 may include a memory 1504, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1504 may include memory that is located on the same integrated circuit die as the processor unit 1502. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1500 can comprise one or more processor units 1502 that are heterogeneous or asymmetric to another processor unit 1502 in the electrical device 1500. There can be a variety of differences between the processing units 1502 in a system in terms of a spectrum of metrics of merit including architectural, microarchitectural, thermal, power consumption characteristics, and the like. These differences can effectively manifest themselves as asymmetry and heterogeneity among the processor units 1502 in the electrical device 1500.

In some embodiments, the electrical device 1500 may include a communication component 1512 (e.g., one or more communication components). For example, the communication component 1512 can manage wireless communications for the transfer of data to and from the electrical device 1500. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1512 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1512 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1512 may operate in accordance with other wireless protocols in other embodiments. The electrical device 1500 may include an antenna 1522 to facilitate wireless communications and/or to receive other wireless communications (such as AM or FM radio transmissions).

In some embodiments, the communication component 1512 may manage wired communications, such as electrical, optical, or any other suitable communication protocols (e.g., IEEE 802.3 Ethernet standards). As noted above, the communication component 1512 may include multiple communication components. For instance, a first communication component 1512 may be dedicated to shorter-range wireless communications such as Wi-Fi or Bluetooth, and a second communication component 1512 may be dedicated to longer-range wireless communications such as global positioning system (GPS), EDGE, GPRS, CDMA, WiMAX, LTE, EV-DO, or others. In some embodiments, a first communication component 1512 may be dedicated to wireless communications, and a second communication component 1512 may be dedicated to wired communications.

The electrical device 1500 may include battery/power circuitry 1514. The battery/power circuitry 1514 may include one or more energy storage devices (e.g., batteries or capacitors) and/or circuitry for coupling components of the electrical device 1500 to an energy source separate from the electrical device 1500 (e.g., AC line power).

The electrical device 1500 may include a display device 1506 (or corresponding interface circuitry, as discussed above). The display device 1506 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1500 may include an audio output device 1508 (or corresponding interface circuitry, as discussed above). The audio output device 1508 may include any embedded or wired or wirelessly connected external device that generates an audible indicator, such as speakers, headsets, or earbuds.

The electrical device 1500 may include an audio input device 1524 (or corresponding interface circuitry, as discussed above). The audio input device 1524 may include any embedded or wired or wirelessly connected device that generates a signal representative of a sound, such as microphones, microphone arrays, or digital instruments (e.g., instruments having a musical instrument digital interface (MIDI) output). The electrical device 1500 may include a Global Navigation Satellite System (GNSS) device 1518 (or corresponding interface circuitry, as discussed above), such as a Global Positioning System (GPS) device. The GNSS device 1518 may be in communication with a satellite-based system and may determine a geolocation of the electrical device 1500 based on information received from one or more GNSS satellites, as known in the art.

The electrical device 1500 may include another output device 1510 (or corresponding interface circuitry, as discussed above). Examples of the other output device 1510 may include an audio codec, a video codec, a printer, a wired or wireless transmitter for providing information to other devices, or an additional storage device.

The electrical device 1500 may include another input device 1520 (or corresponding interface circuitry, as discussed above). Examples of the other input device 1520 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1500 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1500 may be any other electronic device that processes data. In some embodiments, the electrical device 1500 may comprise multiple discrete physical components. Given the range of devices that the electrical device 1500 can be manifested as in various embodiments, in some embodiments, the electrical device 1500 can be referred to as a computing device or a computing system.

The following examples pertain to embodiments in accordance with this Specification. Example 1 is an apparatus including: an optical connector including: a ferrule to accept one or more optical fibers in one or more fiber holes of the ferrule, where the ferrule is formed from a dielectric layer and includes: a face to interface with an optical socket of another device, where ends of the one or more optical fibers are exposed at the face to communicate photon signals with the other device; and alignment features formed in the dielectric layer to align the ends of the one or more optical fibers with one or more waveguides of the other device.

Example 2 includes the subject matter of example 1, where the dielectric layer includes a build-up dielectric.

Example 3 includes the subject matter of any one of examples 1-2, where the optical connector includes a pluggable optical connector configured to removably attach to the optical socket.

Example 4 includes the subject matter of any one of examples 1-3, further including an optical cable, and the optical connector includes a plug of the optical cable.

Example 5 includes the subject matter of any one of examples 1-4, where the ferrule includes a glass encapsulation layer deposited on the dielectric layer.

Example 6 includes the subject matter of any one of examples 1-5, where the dielectric layer has a coefficient of thermal expansion (CTE) within 6 ppm/C of a CTE of the waveguide.

Example 7 includes the subject matter of example 6, where the CTE of the dielectric layer is less than 11 ppm/C.

Example 8 includes the subject matter of any one of examples 1-7, where the alignment features include geometric features manufactured at sub-micron precision.

Example 9 includes the subject matter of example 8, where the alignment features and fiber holes are formed from lithography and etching process steps.

Example 10 includes the subject matter of any one of examples 8-9, where the alignment features include fine alignment features and the ferrule further includes medium alignment features larger than the fine alignment features also formed in the dielectric layer.

Example 11 is a method including: applying a layer of build-up dielectric material on a release layer of a base substrate; applying a mask to the layer of build-up dielectric material; subtracting material from the layer of build-up dielectric material to define one or more instances of a ferrule based on a pattern, where the pattern is based at least in part on the mask; and releasing the one or more instances of the ferrule from the release layer.

Example 12 includes the subject matter of example 11, where at least a portion of the material is subtracted using a dry etch process.

Example 13 includes the subject matter of any one of examples 11-12, where at least a portion of the material is subtracted using a wet etch process.

Example 14 includes the subject matter of any one of examples 11-13, where at least a portion of the material is subtracted using a laser cutting process.

Example 15 includes the subject matter of any one of examples 11-14, further including depositing a layer of silicon oxide on the one or more instances of the ferrule.

Example 16 includes the subject matter of any one of examples 11-15, where the pattern defines a respective set of fiber holes and an alignment feature to be formed in the one or more instances of the ferrule.

Example 17 includes the subject matter of example 16, where the alignment feature includes a fine alignment feature according to a sub-micron tolerance level.

Example 18 includes the subject matter of any one of examples 11-17, where the build-up dielectric layer has a coefficient of thermal expansion (CTE) within 6 ppm/C of a CTE of a waveguide of an optical socket.

Example 19 includes the subject matter of example 18, where the CTE of the dielectric layer is less than 11 ppm/C.

Example 20 includes the subject matter of any one of examples 11-19, where the mask is applied through lithography.

Example 21 is a ferrule of a pluggable optical connector, where the ferrule is manufactured by a method including: applying a layer of build-up dielectric material on a release layer of a base substrate; applying a mask to the layer of build-up dielectric material; subtracting material from the layer of build-up dielectric material to define the ferrule based on a pattern, where the pattern is based at least in part on the mask; and release the ferrule from the release layer.

Example 22 includes the subject matter of example 21, further including one or more fine alignment features formed through one of a chemical etch process or a laser cutting process.

Example 23 includes the subject matter of any one of examples 21-22, where the mask is applied through a lithography process.

Example 24 includes the subject matter of any one of examples 21-23, where the method further includes depositing a layer of silicon oxide on the ferrule.

Example 25 includes the subject matter of any one of examples 21-24, where the pattern defines a respective set of fiber holes and an alignment feature to be formed in the one or more instances of the ferrule.

Example 26 includes the subject matter of example 25, where the alignment feature includes a fine alignment feature according to a sub-micron tolerance level.

Example 27 includes the subject matter of any one of examples 21-26, where the build-up dielectric layer has a coefficient of thermal expansion (CTE) matched to within 6 ppm/C of a CTE of a waveguide of an optical socket.

Example 28 includes the subject matter of example 27, where the CTE of the dielectric layer is less than 11 ppm/C.

Example 29 is a system including: an optical connector device including a ferrule, where the ferrule is formed from a build-up dielectric layer; and a photonic integrated chip (PIC) including an optical socket, where the optical socket includes an interposer, where the ferrule is to align with the interposer to facilitate transmission of photons between the optical connector device and the optical socket, and the build-up dielectric layer has a CTE associated with a CTE of the interposer.

Example 30 includes the subject matter of example 29, where the optical connector device includes an optical cable including a plug, where the plug includes the ferrule.

Example 31 includes the subject matter of example 30, further including a device, where the optical connector device couples the device to the PIC.

Example 32 includes the subject matter of any one of examples 29-31, further including a package, and the PIC is mounted to the package.

Example 33 includes the subject matter of any one of examples 29-32, where the ferrule includes the ferrule of any one of examples 1-10 and 21-28.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. An apparatus comprising:
an optical connector comprising:
a ferrule to accept one or more optical fibers in one or more fiber holes of the ferrule, wherein the ferrule is formed from a dielectric layer and comprises:
a face to interface with an optical socket of another device, wherein ends of the one or more optical fibers are exposed at the face to communicate photon signals with the other device; and
alignment features formed in the dielectric layer to align the ends of the one or more optical fibers with one or more waveguides of the other device.

2. The apparatus of claim 1, wherein the dielectric layer comprises a build-up dielectric.

3. The apparatus of claim 1, wherein the optical connector comprises a pluggable optical connector configured to removably attach to the optical socket.

4. The apparatus of claim 1, further comprising an optical cable, and the optical connector comprises a plug of the optical cable.

5. The apparatus of claim 1, wherein the ferrule comprises a glass encapsulation layer deposited on the dielectric layer.

6. The apparatus of claim 1, wherein the dielectric layer has a coefficient of thermal expansion (CTE) is within 6 parts per million per Celsius degree (ppm/C).

7. The apparatus of claim 6, wherein the CTE of the dielectric layer is less than 11 ppm/C.

8. The apparatus of claim 1, wherein the alignment features comprise geometric features manufactured at sub-micron precision.

9. The apparatus of claim 8, wherein the alignment features and fiber holes are formed from lithography and etching process steps.

10. The apparatus of claim 8, wherein the alignment features comprise fine alignment features and the ferrule further comprises medium alignment features larger than the fine alignment features also formed in the dielectric layer.

11. A method comprising:
applying a layer of build-up dielectric material on a release layer of a base substrate;
applying a mask to the layer of build-up dielectric material;
subtracting material from the layer of build-up dielectric material to define one or more instances of a ferrule based on a pattern, wherein the pattern is based at least in part on the mask; and
releasing the one or more instances of the ferrule from the release layer.

12. The method of claim 11, wherein at least a portion of the material is subtracted using a dry etch process.

13. The method of claim 11, wherein at least a portion of the material is subtracted using a wet etch process.

14. The method of claim 11, wherein at least a portion of the material is subtracted using a laser cutting process.

15. The method of claim 11, further comprising depositing a layer of silicon oxide on the one or more instances of the ferrule.

16. The method of claim 11, wherein the pattern defines a respective set of fiber holes and an alignment feature to be formed in the one or more instances of the ferrule.

17. The method of claim 16, wherein the alignment feature comprises a fine alignment feature according to a sub-micron tolerance level.

18. A ferrule of a pluggable optical connector, wherein the ferrule is manufactured by a method comprising:
applying a layer of build-up dielectric material on a release layer of a base substrate;
applying a mask to the layer of build-up dielectric material;
subtracting material from the layer of build-up dielectric material to define the ferrule based on a pattern, wherein the pattern is based at least in part on the mask; and
releasing the ferrule from the release layer.

19. The ferrule of claim 18, further comprising one or more fine alignment features formed through one of a chemical etch process or a laser cutting process.

20. The ferrule of claim 18, wherein the method further comprises depositing a layer of silicon oxide on the ferrule.
